(19) United States
(12) Patent Application Publication
(10) Pub. No.: US 2011/0136542 A1
(43) Pub. Date: Jun. 9, 2011

(54) METHOD AND APPARATUS FOR SUGGESTING INFORMATION RESOURCES BASED ON CONTEXT AND PREFERENCES

(75) Inventor: Sailesh Kumar Sathish, Tampere (FI)

(73) Assignee: Nokia Corporation, Kspoo (FI)

(21) Appl. No.: 12/634,410

(22) Filed: Dec. 9, 2009

(51) Int. Cl. H04M 1/00; G06F 17/27

(52) U.S. Cl. 455/566; 704/9

(57) ABSTRACT

An approach is provided for suggesting information resources based on context and preferences. A resource manager retrieves a predetermined set of a plurality of information resources associated with the user, extracts language tokens from the information resources, and computes a model of the predetermined set of information resources by applying a probabilistic analysis on the language tokens. The resource manager then matches the model against a context vocabulary to generate a context template for each of the information resources and a preference vocabulary to generate a preference template for each of the information resources.

### BACKGROUND

Service providers (e.g., wireless, cellular, etc.) and device manufacturers are continually challenged to deliver value and convenience to consumers by, for example, providing compelling network services. Increasingly, these network services provide easy access to a vast library of online and offline information resources (e.g., web pages, online databases, local databases, services, applications, etc.). However, users can quickly be overwhelmed by the sheer volume and scope of available information, particularly when the users try to discover and/or access such information resources on a mobile device (e.g., mobile handset, smartphone, etc.) where data entry, display area, processing power, data storage, and the like are limited. In fact, in many cases, the process of sifting through the volume of available information resources to find resources that are relevant or that may interest to users may be so cumbersome that users may give up searching for or simply fail to take advantage of resources that might otherwise be of interest. Accordingly, service providers and device manufactures face significant technical challenges in assisting users to discover and access such resources.

### Some Example Embodiments

Therefore, there is a need for an approach for efficiently suggesting information resources to users based on context and preferences.

According to one embodiment, a method comprises retrieving a predetermined set of a plurality of information resources. The method also comprises extracting language tokens from the information resources. The method further comprises creating a model of the predetermined set of information resources by applying a probabilistic analysis on the language tokens. The method further comprises matching the model against a context vocabulary to generate a context template for each of the information resources. The method further comprises matching the model against a preference vocabulary to generate a preference template for each of the information resources.

According to another embodiment, an apparatus comprising at least one processor, and at least one memory including computer program code, the at least one memory and the computer program code configured to, with the at least one processor, cause, at least in part, the apparatus to retrieve a predetermined set of a plurality of information resources associated with the user. The apparatus is also caused to extract language tokens from the information resources. The apparatus if further caused to create a model of the predetermined set of information resources by applying a probabilistic analysis on the language tokens. The apparatus is further caused to match the model against a context vocabulary to generate a context template for each of the information resources. The apparatus is further caused to match the model against a preference vocabulary to generate a preference template for each of the information resources.

According to another embodiment, a computer-readable storage medium carrying one or more sequences of one or more instructions which, when executed by one or more processors, cause, at least in part, an apparatus to retrieve a predetermined set of a plurality of information resources associated with the user. The apparatus is also caused to extract language tokens from the information resources. The apparatus if further caused to create a model of the predetermined set of information resources by applying a probabilistic analysis on the language tokens. The apparatus is further caused to match the model against a context vocabulary to generate a context template for each of the information resources. The apparatus is further caused to match the model against a preference vocabulary to generate a preference template for each of the information resources.

According to another embodiment, an apparatus comprises means for retrieving a predetermined set of a plurality of information resources associated with the user. The apparatus also comprises means for extracting language tokens from the information resources. The apparatus further comprises means for creating a model of the predetermined set of information resources by applying a probabilistic analysis on the language tokens. The apparatus further comprises means for matching the model against a context vocabulary to generate a context template for each of the information resources. The apparatus further comprises means for matching the model against a preference vocabulary to generate a preference template for each of the information resources.

Still other aspects, features, and advantages of the invention are readily apparent from the following detailed description, simply by illustrating a number of particular embodiments and implementations, including the best mode contemplated for carrying out the invention. The invention is also capable of other and different embodiments, and its several details can be modified in various obvious respects, all without departing from the spirit and scope of the invention. Accordingly, the drawings and description are to be regarded as illustrative in nature, and not as restrictive.

### BRIEF DESCRIPTION OF THE DRAWINGS

The embodiments of the invention are illustrated by way of example, and not by way of limitation, in the figures of the accompanying drawings:

FIG. 1 is a diagram of a system capable of suggesting information resources based on context and preferences, according to one embodiment;

FIG. 2 is a diagram of the components of a resource manager, according to one embodiment;

FIGS. 3A and 3B are flowcharts of a process for suggesting information resources based on context and preferences, according to one embodiment;

FIG. 4 is a flowchart of a process for establishing a hierarchy of contextual characteristics and preferences for suggesting information resources, according to one embodiment;

FIG. 5 is a flowchart of a process for suggesting information resources defined by third parties, according to one embodiment;

FIG. 6 is a diagram of hardware that can be used to implement an embodiment of the invention;

FIG. 7 is a diagram of a chip set that can be used to implement an embodiment of the invention; and

FIG. 8 is a diagram of a mobile terminal (e.g., handset) that can be used to implement an embodiment of the invention.

### DESCRIPTION OF SOME EMBODIMENTS

Examples of a method, apparatus, and computer program for suggesting information resources based on context and preferences are disclosed. In the following description, for the purposes of explanation, numerous specific details are set forth in order to provide a thorough understanding of the embodiments of the invention. It is apparent, however, to one skilled in the art that the embodiments of the invention may be practiced without these specific details or with an equivalent arrangement. In other instances, well-known structures and devices are shown in block diagram form in order to avoid unnecessarily obscuring the embodiments of the invention.

As used herein, the term “information resources” refers to any entity or object that is addressable or otherwise identifiable in an information system (e.g., the Internet, a private network, local device storage, network storage, etc.). By way of example, information resources may include web pages, documents, files, images, services, applications, etc. In one embodiment, information resources are identified using a Uniform Resource Identifier (URI) that can encompass both a Uniform Resource Locator (URL) and/or a Uniform Resource Name (URL). It is also contemplated an information resource may be identified using any network naming or identification system.

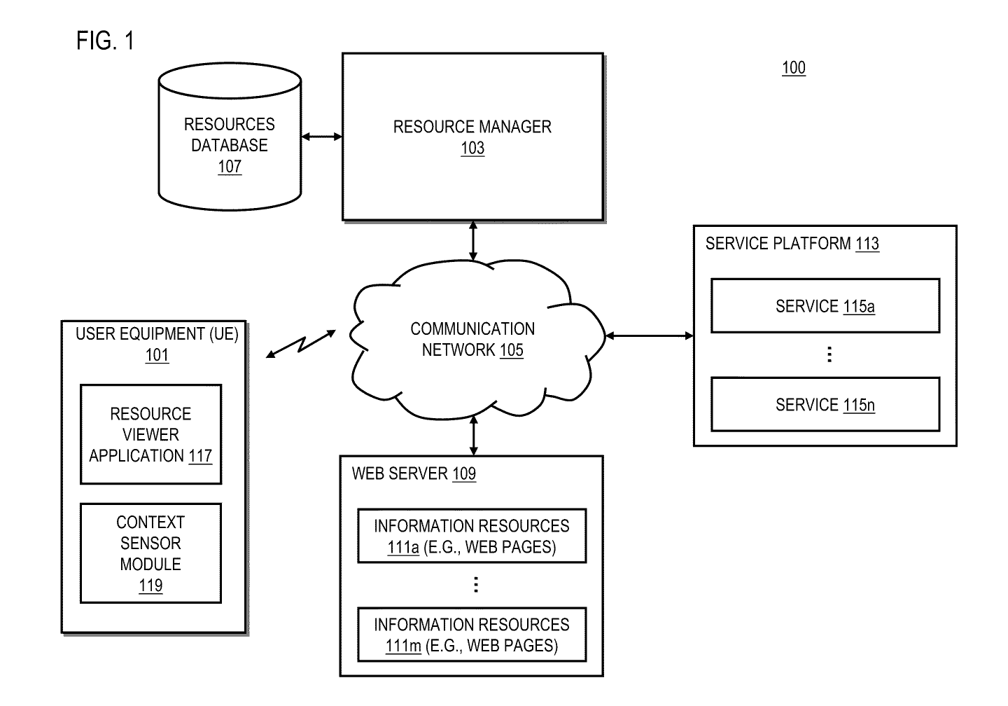

FIG. 1 is a diagram of a system capable of suggesting information resources based on context and preferences, according to one embodiment. As described previously, one key challenge facing service providers and device manufacturers is how to provide for discovery and access to information resources that are relevant to or that may interest a user from among the vast array of information resources (e.g., web pages, files, documents, etc.) available over the Internet or other information systems. Historically, users have relied on search engines (e.g., Google, Yahoo, Bing, etc.) that try to index the entire web or network of information resources for retrieval by users. It is noted that search engine providers have spent enormous resources developing and implementing the search engines so that they can compile and analyze web content for users. However, these search engines still generally require users to manually enter search terms and other criteria to find information of interest. Moreover, because of the expansive nature of most search engines, users often must possess at least a certain level of expertise and skill with the search engines to be effective at finding information. Otherwise, users can still face the daunting task of sifting through page upon page of search results.

To address these problems, a system 100 of FIG. 1 introduces the capability of automatically suggesting one or more information resources from a predetermined set of information resources associated with a user. In one embodiment, the predetermined set of information resources is specified by the user, a community of users, or third parties (e.g., businesses, organizations, etc.) to reflect the general interest or preferences of the user. In this way, the system 100 advantageously limits the amount of information that is processed to provide suggested information resources, thereby advantageously reducing the resources requirements in comparison to the traditional search engine approach. For example, traditional search engines use resources for cataloging the entire web.

More specifically, the system 100 analyzes the information referenced in the information resources to construct a language model of the predetermined set using, for instance, data mining techniques (e.g., word parsing followed by a probabilistic analysis of the parsed words to categorize the information resources) to generate corresponding context and preference templates (e.g., data structures) that reflect the content of each of the information resources. The same data mining techniques can also be used to determine and analyze information associated with the contextual characteristics (e.g., time, location, current activity, historical activity, etc.) of the user's devices and with the user's information resource preferences (e.g., language preferences, category of information preferences, interest areas, etc.). In one embodiment, the system 100 can then match the determined contextual characteristics and preferences against the generated context and preference templates to suggest information resources to the user. These suggestions can then be displayed on the user's device and automatically updated as the contextual characteristics of the device change. An advantage of this approach is that the user is always presented with an updated list of information resources that are likely to be contextually or preferentially relevant to the user without specific user intervention. In one embodiment, the list provides a direct link (e.g., via a URI) to the information resource, and the user need only click on the link to immediately access the suggested information resource. Further, the system 100 may store login credentials and/or other access information related to the suggested information resource to facilitate quick access to the information resource. In this way, the user need not laboriously enter access information or search for information corresponding to resources.

In yet another embodiment, the system 100 enables third parties (e.g., advertisers, businesses, organizations, user communities, social networking groups, etc.) to specify or contribute to the predetermined set of information resources from which the system 100 will make suggestions. Enabling this function advantageously allows the user to leverage the favorite information resources, preferences, and/or context of other parties that may share similar interest, so that the user need not be responsible for defining the entire predetermined set of information resources. By way of example, these third parties may also include external bookmarking services (e.g., Digg, Facebook, Delicious, etc.) that tag and categorize information resources (e.g., web pages) based on user preferences. As another example, a business may define information resources related to the business (e.g., product suggestions, special sales, etc.) and the context in which the business-related information resources will be presented to the user. For instance, an advertiser may trigger the suggestion of an online product catalog if the user searches for a particular product on the user's device. The system 100 can then monitor for when the context arises and suggest the business-related information resource accordingly.

As shown in FIG. 1, a user equipment (UE) 101 exchanges context and preference information with a resource manager 103 via the communication network 105. For the sake of simplicity, FIG. 1 depicts only a single UE 101 in the system 100. However, it is contemplated that the system may support any number of UEs 101 up to the maximum capacity of the communication network 105. For example, the network capacity may be determined based on available bandwidth, available connection points, and/or the like. As described previously with respect to the system 100, the resource manager 103 uses the context and preference information to automatically generate suggestions for potentially relevant information resources to present at the UE 101. In the example of FIG. 1, the resource manager 103 stores context, preference, and/or resource information in the resources database 107. By way of example, the resource information includes one or more identifiers, metadata, access addresses (e.g., network addresses such as a URI, URL, URN, or Internet Protocol address; or a local address such as a file or storage location in a memory of the UE 101), description, categories, preference information, or the like associated with the information resources. In one embodiment, one or more of the information resources may be provided by the web server 109 which includes one or more information resources 111a-111n (e.g., web pages, documents, files, media, etc.) or by the service platform 113 which includes services 115a-115m (e.g., music service, mapping service, video service, social networking service, content broadcasting service, etc.).

In certain embodiments, the resource manager 103 interacts with a resource viewer application 117 executing on the UE 101 to automatically display suggested information resource recommendations. The resource viewer application 117 displays, for instance, a user interface that shows a list of information resources 111 and/or links to the information resources 111 (e.g., identified by corresponding URIs) that changes as the context of the UE 101 changes. In one use case, the user need only to check the user interface for the list and click on the appropriate one of the information resource to access the resource and, if necessary, invoke a corresponding application or service. For example, if the information resource is a web page, clicking on the resource invokes a browser application (not shown) on the UE 101 to display the web page. In one embodiment, the resource viewer application 117 may operate on a common Web Run Time (WRT) platform as a client application of the resource manager 103. In addition or alternatively, the resource viewer application can be implemented in another programming language or development tool including Java, Qt, and the like.

The UE 101 also includes a context sensor module 119 for detecting or sensing one or more contextual characteristics (e.g., time, location, current activity, etc.) associated with device. This contextual information can then be transmitted to the resource manager 103 for use in generating the suggested list of information resources 111. By way of example, the context sensor module 119 may include one or more of a global positioning system (GPS) receiver for determining location, an accelerometer to determine movement or tilt angle, a magnetometer to determine directional heading, a microphone to determine ambient noise, a light sensor, a camera, and/or the like. In addition or alternatively, the resource manager 103 may obtain contextual information from one or more of the services 115a-115m (e.g., a weather service, a location tracking service, social network service, etc.).

By way of example, the UE 101 is any type of mobile terminal, fixed terminal, or portable terminal including mobile handsets, mobile phones, mobile communication devices, stations, units, devices, multimedia tablets, digital book readers, game devices, audio/video players, digital cameras/camcorders, positioning device, televisions, radio broadcasting receivers, Internet nodes, communicators, desktop computers, laptop computers, Personal Digital Assistants (PDAs), or any combination thereof. Under this scenario, the UE 101 employs wireless links (e.g., cellular radio links) to access the communication network 105 and/or the resource manager 103. In addition or alternatively, it is contemplated that the UE 101 may also employ wired connections (e.g., wired Ethernet connections) to the network 105 and/or the resource manager 103. It is also contemplated that the UEs 101a-101n can support any type of interface to the user (such as “wearable” circuitry, etc.).

Additionally, in certain embodiments, the communication network 105 of system 100 includes one or more networks such as a data network (not shown), a wireless network (not shown), a telephony network (not shown), or any combination thereof. It is contemplated that the data network may be any local area network (LAN), metropolitan area network (MAN), wide area network (WAN), a public data network (e.g., the Internet), or any other suitable packet-switched network, such as a commercially owned, proprietary packet-switched network, e.g., a proprietary cable or fiber-optic network. In addition, the wireless network may be, for example, a cellular network and may employ various technologies including enhanced data rates for global evolution (EDGE), general packet radio service (GPRS), global system for mobile communications (GSM), Internet protocol multimedia subsystem (IMS), universal mobile telecommunications system (UMTS), etc., as well as any other suitable wireless medium, e.g., worldwide interoperability for microwave access (WiMAX), Long Term Evolution (LTE) networks, code division multiple access (CDMA), wideband code division multiple access (WCDMA), wireless fidelity (WiFi), satellite, mobile ad-hoc network (MANET), and the like.

By way of example, the UE 101, resource manager 103, web server 109, and service platform 113 communicate with each other and other components of the communication network 105 using well known, new or still developing protocols. In this context, a protocol includes a set of rules defining how the network nodes within the communication network 105 interact with each other based on information sent over the communication links. The protocols are effective at different layers of operation within each node, from generating and receiving physical signals of various types, to selecting a link for transferring those signals, to the format of information indicated by those signals, to identifying which software application executing on a computer system sends or receives the information. The conceptually different layers of protocols for exchanging information over a network are described in the Open Systems Interconnection (OSI) Reference Model.

Communications between the network nodes are typically effected by exchanging discrete packets of data. Each packet typically comprises (1) header information associated with a particular protocol, and (2) payload information that follows the header information and contains information that may be processed independently of that particular protocol. In some protocols, the packet includes (3) trailer information following the payload and indicating the end of the payload information. The header includes information such as the source of the packet, its destination, the length of the payload, and other properties used by the protocol. Often, the data in the payload for the particular protocol includes a header and payload for a different protocol associated with a different, higher layer of the OSI Reference Model. The header for a particular protocol typically indicates a type for the next protocol contained in its payload. The higher layer protocol is said to be encapsulated in the lower layer protocol. The headers included in a packet traversing multiple heterogeneous networks, such as the Internet, typically include a physical (layer 1) header, a data-link (layer 2) header, an internetwork (layer 3) header and a transport (layer 4) header, and various application headers (layer 5, layer 6 and layer 7) as defined by the OSI Reference Model.

In one embodiment, the resource viewer application 117 and the resource manager 103 may interact according to a client-server model. According to the client-server model, a client process sends a message including a request to a server process, and the server process responds by providing a service (e.g., providing map information). The server process may also return a message with a response to the client process. Often the client process and server process execute on different computer devices, called hosts, and communicate via a network using one or more protocols for network communications. The term “server” is conventionally used to refer to the process that provides the service, or the host computer on which the process operates. Similarly, the term “client” is conventionally used to refer to the process that makes the request, or the host computer on which the process operates. As used herein, the terms “client” and “server” refer to the processes, rather than the host computers, unless otherwise clear from the context. In addition, the process performed by a server can be broken up to run as multiple processes on multiple hosts (sometimes called tiers) for reasons that include reliability, scalability, and redundancy, among others.

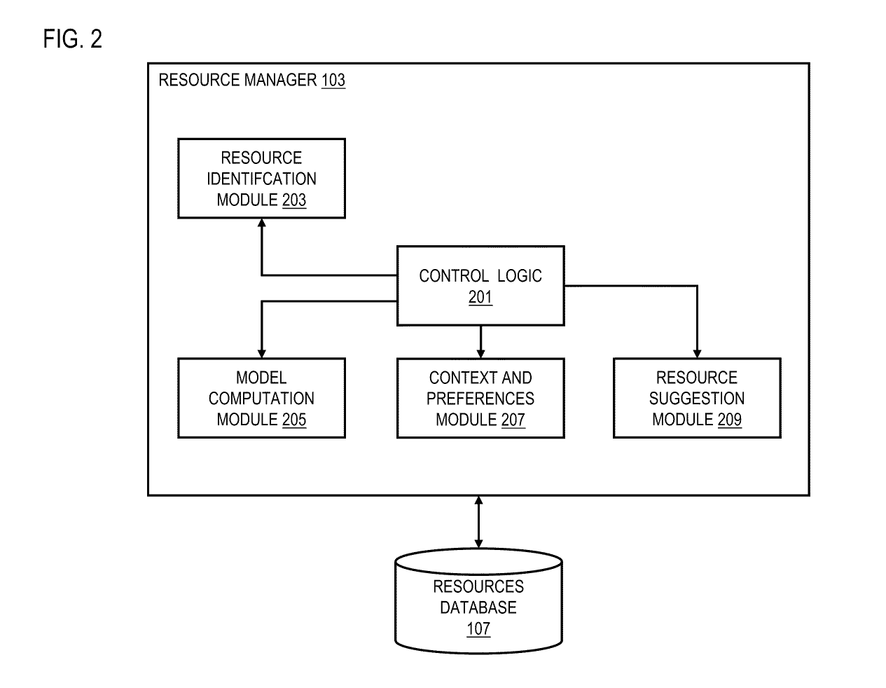

FIG. 2 is a diagram of the components of a resource manager, according to one embodiment. By way of example, the resource manager 103 includes one or more components for presenting suggesting information resources 111 based on contextual and preferential information. It is contemplated that the functions of these components may be combined in one or more components or performed by other components of equivalent functionality. In this embodiment, the resource manager 103 includes at least a control logic 201 which executes at least one algorithm for performing functions of the resource manager 103. For example, the control logic 201 interacts with a resource identification module 203 to specify and/or retrieve a predetermined set of a plurality of information resources 111 associated with a user.

In one embodiment, the resource identification module 203 supports a user interface executing on, for instance, the resource viewer application 117 to receive input from the user, a community or group of users, and/or other third parties (e.g., businesses, service providers, network operators, content providers, etc.) for specifying one or more predetermined sets of information resources 111. In addition or alternatively, the resource identification module 203 can provide a web-based interface or portal (e.g., Nokia's Ovi.com) for entering information related to the set of information resources 111. In one example, the user interface (e.g., either running the application 117 or the web-based interface) is provided for the user to enter a set of information resources 111 (e.g., favorite web pages, online databases, applications, services, etc.). It is contemplated that the user may link to external bookmarking sites (e.g., Digg, Delicious, etc.), other programs (e.g., a web browser), or services (e.g., social networking services) to obtain links to information resources 111. In addition, the user interface enables the user to specify personal preferences or other data (e.g., login credentials or other access credentials) associated with each information resource. The predetermined set of information resources 111, preferences, and related information are then stored in, for instance, the resources database 107.

In one embodiment, the resource identification module 203 can store the information based on an identifier associated with the user or the UE 101 (e.g., a telephone number of the UE 101). Examples of information elements stored as part of the predetermined set of information resources 111 are listed and explained in Table 1 below.

TABLE 1

| Information Element | Description |
|---|---|
| User Identifier | e.g., telephone number |
| User Device Model | e.g., to identify device capabilities |
| Age | — |
| Nationality | — |
| Language Preferences | — |
| Interest Areas | May be user specified or selected from |
| | a predefined list. |
| Information Resource | The list of information resources |
| List | entered manually |
| External Links to | External links for retrieving |
| Information Resources | information resources specified in, e.g., |
| | an external social networking site |
| Login Credentials | Login credentials to access the listed |
| | information resources of external links |

When entering a list of information resources 111, the user can also be prompted to enter additional optional details about the resource as listed in Table 2.

TABLE 2

| Information Element | Description |
|---|---|
| Category | Describes to which category or |
| | categories the information resources |
| | belongs. This field may also be |
| | determined by data mining. |
| Subcategory | Describes to which subcategory or |
| | subcategories the information resources |
| | belongs. This field may also be |
| | determined by data mining. |
| Category Preference | Describes what categories are preferred |
| | by the user. |
| Time Preference | Describes during which time periods |
| | the information resource is preferred. |
| Spatial Preference | Describes at what locations the |
| | information resource is preferred. |

In another embodiment, third parties (e.g., businesses, advertisers, etc.) may specify information resources 111 for access by the user under certain contexts. In addition, the third party may specify the context or contextual information for which the information resource would become relevant. The context data that can be specified include the optional information elements listed in Table 3. This context data can then be incorporated into the context template generated for the information resource.

TABLE 3

| Information Element | Description |
|---|---|
| Location | Describes location(s) at which the |
| | information resource is applicable. |
| Active Dates | Describes the range of dates for which |
| | the information resource is effective. |
| Product Type | Describes the products or services |
| | offered by the third party, if any. |
| Sub-identifiers | Each sub-identifier can be associated |
| | with a different location and/or |
| | applicable context |
| Event type | Event information associated with the |
| | information resource. |
| Time | Provides the time of the event if the |
| | information resource is an event type. |
| Applicable context | Describes the context or contexts in |
| | which the information resource is |
| | applicable. |
| Context source | Describes what sensors, services, |
| | applications, etc. can provide the |
| | related contextual information. |
| Category Preference | Describes what categories are preferred |
| | by the user. |
| Time Preference | Describes during which time periods |
| | the information resource is preferred. |
| Spatial Preference | Describes at what locations the |
| | information resource is preferred. |

In one embodiment, the information elements described in Tables 1-3 may be synchronized among or stored in the resources database 107, the UE 101, and/or other component of the communication network 105.

After identifying or determining the predetermined set of information resources 111 associated with the user, the control logic 201 interacts with the model computation module 205 to create a model or language model that describes the most prevalent or main words or terms that appear in each of the information resources 111. By way of example, for each information resource, text or other information is extracted from the information sources in the predetermined set as language tokens (e.g., each language token represents a word or phrase). For instance, each of the information resources 111 is crawled and parsed to obtain text. Since the text data are largely unstructured and can comprise tens of thousands of words, automated topic modeling can be used for locating and extracting language tokens from the text. In one embodiment, the model computation module 205 extracts the noun tokens, and then performs a histogram cut to extract only the least common nouns. To extract the noun tokens, the model computation module 205 can deploy a part-of-speech tagging (POTS) to mark up nouns in the text. POTS is a process of marking up nouns in a text (corpus) as corresponding to a particular part of speech, based on both its definition, as well as its context. Part-of-speech tagging is more than just having a list of words and their parts of speech, because some words can represent more than one part of speech at different times. For example, “dogs” is usually a plural noun, but can be a verb. The model computation module 205 then extracts nouns using a language dictionary, and stores the noun tokens as a noun set.

The noun set obtained is then used to build a model to represent the predetermined set of information resources 111 by extracting tokens with similar probability and range from a larger language model (e.g., Wikipedia or other large collection of meaningful words) or performing other similar probabilistic analysis of the tokens. In one example, topic models, such as Latent Dirichlet Allocation (LDA), are useful tools for the statistical analysis of document collections. For example, LDA is generative probabilistic model as well as a “bag of words” model. In other words, the words or tokens extracted from text of the information resources 111 are assumed to be exchangeable within them. The LDA model assumes that the words of each document arise from a mixture of topics, each of which is a probability distribution over the vocabulary. As a consequence, LDA represents documents as vectors of word counts in a very high dimensional space, while ignoring the order in which the words or tokens appear. While it is important to retain the exact sequence of words for reading comprehension, the linguistically simplistic exchangeability assumption is essential to efficient algorithms for automatically eliciting the broad semantic themes in a collection of language token.

Another example of a modeling algorithm is the probabilistic latent semantic analysis (PLSA) model. PLSA is a statistical technique for analyzing two-mode and co-occurrence data. PLSA was evolved from latent semantic analysis, and added a sounder probabilistic model. PLSA has applications in information retrieval and filtering, natural language processing, machine learning from text, and related areas.

Once the language model for the information resources 111 is created, the model computation module 205 can then generate templates (e.g., data structures) to reflect the content expressed in each information resource. In one embodiment, the model computation module 205 creates a context template and a preference template for each information resource. The context template, for instance, represents language tokens included in the model that match a predetermined vocabulary of context related terms. In other words, a match between a language token included in the model and a term within the predetermined context vocabulary causes the context term to be included in the context template. Inclusion in the context template means that the context term describes a context condition (e.g., a time, place, location, activity, etc.), a context source (e.g., a service or sensor that provides that contextual characteristics to determine a particular context condition), and/or other context-related information associated with the information resource. Similarly, the model computation module 205 can generate a preference template by matching the model against a predetermined vocabulary of preferences. Tokens matching preference-related terms are then included in the preference template. In one embodiment, the model computation module can create an individual preference template for each information resource or an overall preference template for the entire predetermined set of information resources 111. Creating preference templates on an individual information resource basis advantageously enables the resource manager 103 to determine specific information sources that match user preferences with greater granularity, while an overall preference template for the entire set provides a more complete picture of user preferences as determined by the information sources selected for inclusion in the predetermined set.

Next, the control logic 201 interacts with the context and preferences module 207 to determine contextual and preferential information associated with the user or the user's device for matching against the generated context and preference templates. In one embodiment, both the context and preference templates (e.g., data structures) have a standard list of fields. The fields that go into each template or data structure can be predefined and include any number of fields. By way of example, with respect to the preference template, each field represents an individual preference parameter such as a language preference, category preference, etc. To compare the preferences of the UE 101 against the preference template, the context and preferences module 207 computes a probability metric for each of the fields of the template against the UE 101's specified preference information for each of the information resources 111. In one embodiment, the probability of each field in the preference template is stored in a separate structure from other descriptive information about the corresponding information resource. This process is repeated for all of the information resources 111 in the model and the average metric for each field across all information sources is computed and stored in the preference data structure.

Next, the context and preferences module 207 calculates an entropy (or uncertainty) for each of the information resources 111 using the probability metric for each field computed for that information resource. In one embodiment, this calculation is performed according to the following equation:

H(x)=ΣPi(x)log 2Pi(x)

where x is the information resource and i denotes the fields in the preference data structure.

The context and preferences module 207 analyzes each information resource and a mark is made against the probability for one or more of the “n” number of preference parameters that the user is interested in. Then, a decision tree is built for each parameter. It is contemplated that the user can define any number of preference parameters to match against the corresponding templates. In addition or alternatively, an inference engine can decide what parameters or attributes to choose to represent user interest or preferences. Then, that particular decision tree is chosen to represent the dominant preference parameter and assigned a value. It is noted that the values for other preference parameters are also taken into account. The values are then run over the particular decision tree and a unique path is computed that satisfies the preference parameter values. Each path in the tree identifies a unique information resource to suggest to the user.

In another embodiment, the context and preferences module 207 can suggest information resources 111 based on contextual information. The contextual information about the UE 101 is, for instance, retrieved or determined from the UE 101. In addition or alternatively, the contextual information can be determined by a service 115, another UE 101, a group or community of UEs 101 or users, or a combination thereof. More specifically, the resource viewer application 117, in conjunction with the context sensor module 119, determines the current context associated with the UE 101 and transmits the context information to the resource manager 103. For instance, the resource viewer application 117 uses AJAX to send extensible markup language (XML) wrapped context data structures to the resource manager 103. The context and preferences module 207 can send the requested context update data structures to the application 117. The ontology information will be encoded within the context data structure requested by the module 119 and the application 117 can use one of many ways to obtain the data. One way is to use, for instance, a W3C DCCI (new version) extension to WRT that provides context data via context objects. In addition, the context and preferences module 207 can use contextual access application programming interfaces (APIs) to directly retrieve contextual information from the UE 101. The contextual information may include, for instance, a date, a time, a location, a current activity of the user, a history of activity, or a combination thereof. The contextual information is then matched against the context templates generated as described above for each of the information resources 111 to determine a suggested list of information resources 111 that may be relevant to the determined context of the UE 101.

The identified information resources 111 are then presented to the user via the resource suggestion module 209. As discussed previously, the suggestion module 209 renders the suggested list of information resources 111 on the UE 101 and updates the list based on changes in contextual information, a predetermined time interval, or a combination thereof.

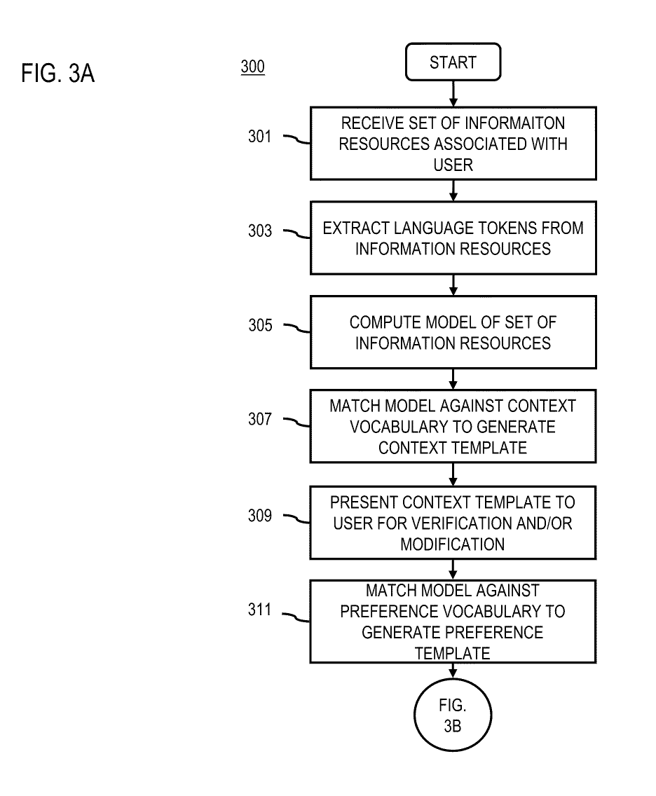

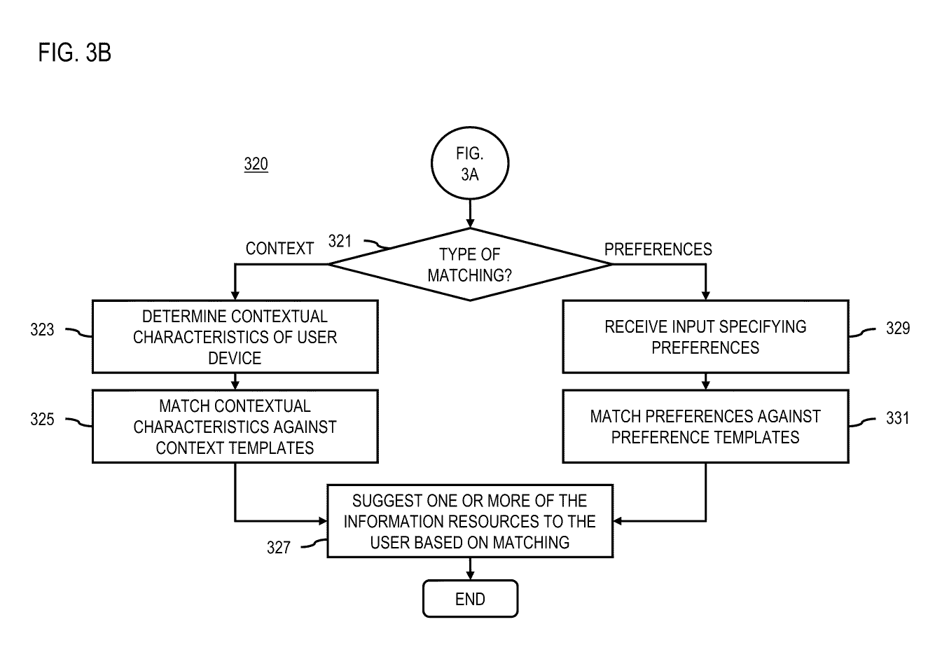

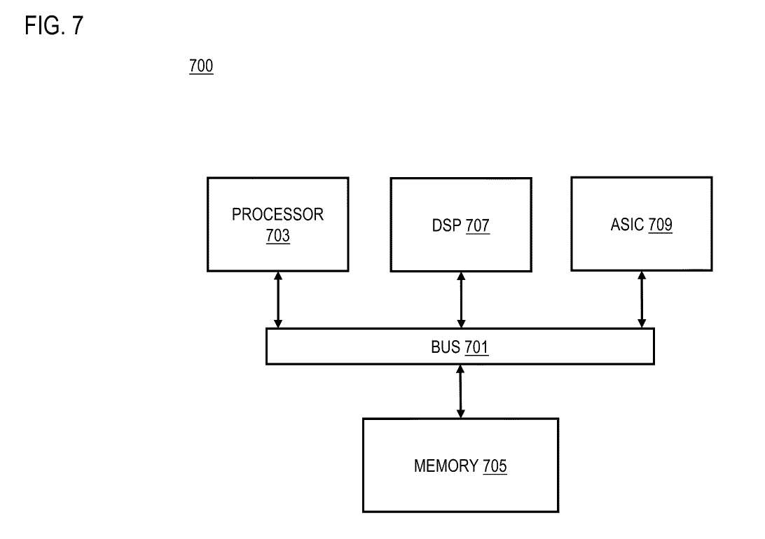

FIGS. 3A and 3B are flowcharts of a process for suggesting information resources based on context and preferences, according to one embodiment. In one embodiment, the resource manager 103 performs the process 300 of FIG. 3A and the process 320 of FIG. 3B and is implemented in, for instance, a chip set including a processor and a memory as shown in FIG. 7. The process 300 of FIG. 3A describes the beginning of the process for suggesting information resources 111 and continues to the process 320 of FIG. 3B. As shown in FIG. 3A, in step 301, the resource manager 103 retrieves a predetermined set of a plurality of information resources 111 associated with a user. The predetermined set may include any number of information resources 111 that have been specified by the user, another user, a group of users, a third party, etc. In the approach described herein, the set of information resources 111 represents those information resources 111 that the user or the UE 101 is likely to find relevant in one context or another.

Next, the resource manager 103 initiates the process for creating a language model of the retrieved information sources according to the process described above with respect to FIG. 2. Creation of the language model enables the resource manager 103 to infer the general topics, subjects, meaning, categories, subcategories, of information contained within or supplied by the information resources 111. More specifically, the resource manager 103 processes (e.g., by crawling and parsing) the information resources 111 to obtain the textual components of the information resources 111, and then extracts the language tokens from the information resources 111 for further analysis (step 303).

The analysis involves, for instance, associating the different language tokens based on word meaning, context, correlation, and the like using clustering algorithms such as LDA or PLSA to group language tokens into a model representing the set of information resources 111 (step 305). Several iterations of the algorithm may be executed over the language tokens to get a desired or set level of refinement of token groupings and compute the model. Once the language tokens are clustered in a model, the resource manager 103 determines categories (e.g., interest categories, subject categories, etc.) by matching the clustered language tokens against a more general language model (e.g., a model based on Wikipedia or a subset thereof). In one embodiment, the general language model describes a vocabulary of terms related to context conditions (e.g., time, location, activity, etc.), context sources (e.g., sensors, services, applications, etc.), and other context-related information as described previously. The resource manager 103 then uses the results of a probabilistic matching analysis between the model of the information resources 111 and the context vocabulary to generate a context template or data structure (e.g., including any number of fields or attributes) to represent the context expressed by the content of each information resource (step 307). In some embodiments, the resource manager 103 presents the automatically generated context template to the user for verification and/or approval (step 309). For example, the user can review the fields and attributes of the context template and modify them as needed. In this way, the user can add, delete, or modify fields to customize the context template for any of the information resources 111 by, for instance, changing any of the determined context conditions and/or sources.

In another embodiment, the general language model describes a vocabulary of terms related to preference information (e.g., language preferences, preferred information resources 111, favorite authors, etc.). Like the process described with respect to context template above, the resource manager 103 performs a probabilistic matching of the model of the information resources 111 against the preference information vocabulary to generate preference templates representing the preferences expressed in each individual information resource in the predetermined set of resources or the entire set as a whole (step 311). The process 300 then continues to the process 320 of FIG. 3B.

As shown in FIG. 3B, after generating the context and preference templates, the resource manager 103 determines whether to match the templates against contextual information, preferential information, or a combination thereof determined from the UE 101 (step 321). If matching against the contextual template, the resource manager 103 sends a request to the UE 101 (e.g., via the resource viewer application 117) to determine contextual characteristics or information (e.g., time, location, activity, history, etc.) at the UE 101 (step 323). In addition or alternatively, the resource manager 103 may determine contextual information about the UE 101 from other devices (e.g., other UEs 101 that may be in communication with the subject UE 101), communities (e.g., social networking communities to which the UE 101 belongs), and/or services 115 (e.g., location services, weather services, music services, etc.) subscribed to by the UE 101. For example, a music service may provide contextual information that the UE 101 is currently listening to music. The context of listening to music may then trigger the suggestion of related information resources 111 (e.g., online reviews, popularity charts, background about the artist, etc.). The resource manager 103 can then match the determined contextual characteristics of the UE 101 against the context templates for each of the information resources 111 (step 325) to suggest one or more relevant information sources (step 327).

If matching against preferential information, the resource manager 103 can receive input specifying preference criteria from either the UE 101 or from other devices, communities, services, and the like that can define such criteria for the UE 101 (step 329). Then, the resource manager 103 can retrieve the preference templates or data structures generated for the information resources 111 and matches the received preference information against the preference templates to determine, for instance, which of the information sources best matches the specified preference criteria (step 331). Based on the matching, the resource manager 103 suggests one or more relevant information resources 111 to the UE 101 (step 327).

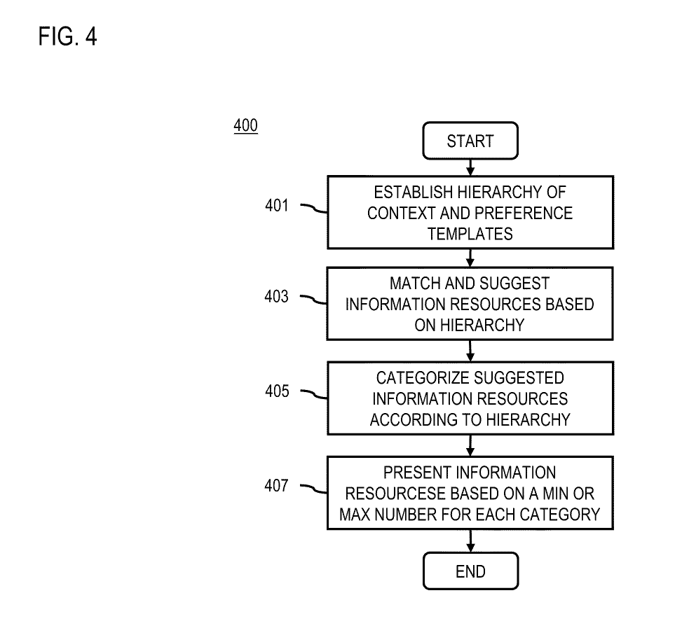

FIG. 4 is a flowchart of a process for establishing a hierarchy of contextual characteristics and preferences for suggesting information resources 111, according to one embodiment. In one embodiment, the resource manager 103 performs the process 400 and is implemented in, for instance, a chip set including a processor and a memory as shown in FIG. 7. The process 400 describes an embodiment that combines contextual and preferential information to suggesting a list of relevant information resources 111. In step 401, the resource manager 103 establishes a hierarchy of different combinations of contextual and preferential information. This hierarchy may be predetermined or may be specified by the user. By way of example, the resource manager 103 may set the following hierarchy: (1) match based on a combination of context and preference specified by the user; (2) match based on current context specified by the user only; (3) match based on preferences specified by the user only; (4) match based on a combination of context and preference specified by a group of users; (5) match based on context specified by a group of users only; and (6) match based on preferences specified by a group of users only. It is contemplated that the any combination or number of hierarchy levels may be specified. The resource manager 103 then matches the hierarchy against the context and preference templates and suggests information resources 111 based on the established hierarchy (step 403).

In one embodiment, the resource manager 103 may also categorize and present the suggested information resources 111 according to the different levels of the hierarchy. For example, all information resources 111 matching the first criterion level of the hierarchy can be grouped and displayed, then the second criterion level, and so on (step 405).

In certain embodiments, the resource manager 103 need not go through all scenarios or levels of the hierarchy if a preset number of information resources 111 are found to be matching. For example, the resource manager 103 can set a maximum number of 10 information resources 111 to present at any given time. Therefore, if 10 information resources 111 are found from a combination of context and preference specified by the user (i.e., the first level of the hierarchy), then additional matching need not be performed, and other levels of the hierarchy are not taken into account. This limitation advantageously reduces the potential to clutter the display area available for presenting the information at the UE 101. Additionally, the reduced number further limits the potential to overwhelm the user with a long list of suggestions. Alternatively, the user or the resource manager 103 can set both a minimum and a maximum number of information resources 111 to suggest in each hierarchy level. The resource manager 103 then presents the suggested information resources 111 based on the specified minimums and maximums for the levels of the hierarchy (step 407).

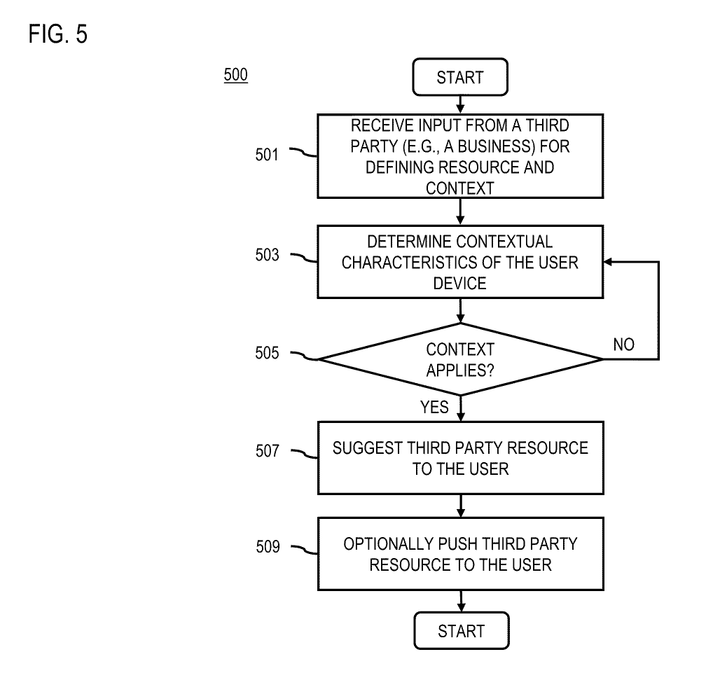

FIG. 5 is a flowchart of a process for suggesting information resources 111 defined by third parties, according to one embodiment. In one embodiment, the resource manager 103 performs the process 500 and is implemented in, for instance, a chip set including a processor and a memory as shown in FIG. 7. Although the process 500 is discussed with respect to a third party that is a business or advertiser with the resource management service, it is contemplated that third party may be any entity capable of specifying and/or identifying information resources 111 and their applicable contexts. In step 501, the resource manager 103 receives input from a third party for defining an information resource (step 501). This information resource may be, for instance, a web page providing product or marketing information. The third party may also specify a context that will trigger the resource manager 103 to suggest the information resource. For example, a business may offer a web page displaying a coupon for a product if the context is the UE 101 entering a store front of the business. In one embodiment, the third party specifies the applicable context by filling in part or all of the fields or attributes of the corresponding context template. In certain embodiments, the context template may be further supplemented by the resource manager 103 using the data mining and modeling processes described with respect to FIGS. 2 and 3.

On defining the third party information resource and if permitted by the UE 101 (e.g., if privacy settings allow), the resource manager 103 incorporates the third party information resource into the predetermined set of information resources 111 specified for a particular user or UE 101. Next, the resource manager 103 periodically requests determination of the contextual characteristics (step 503) to determine whether the context applies (step 505). If the context does not apply, the resource manager 103 continues to monitor for context information until otherwise directed to stop such monitoring. When the contextual characteristics of the UE 101 matches the applicable context of the third party information resource, the resource manager 103 suggests the third party information resource to the user by displaying the link to the resource in the resource viewer application 117 of the UE 101 (step 507). In addition or alternatively, the resource manager 103 may push the third party information resource to the UE 101 so that the resource may be made immediately available to the user (step 509).

With the approach described herein, the system 100 advantageously avoids the resource requirements of trying to index or analyze the entirety of the Internet or web. Instead, the system 100 analyzes only those information resources 111 that have been specified by the user or groups (e.g., community groups, social networking groups, third party businesses, etc.) approved or agreed to by the user, thereby reducing the bandwidth and computational resources for suggesting relevant information resources 111. Moreover, the system 100 reduces the burden on users by automatically providing contextually and preferentially relevant information resources 111 with minimal direct user interaction.

The processes described herein for suggesting information resources 111 based on context and preferences may be advantageously implemented via software, hardware (e.g., general processor, Digital Signal Processing (DSP) chip, an Application Specific Integrated Circuit (ASIC), Field Programmable Gate Arrays (FPGAs), etc.), firmware or a combination thereof. Such exemplary hardware for performing the described functions is detailed below.

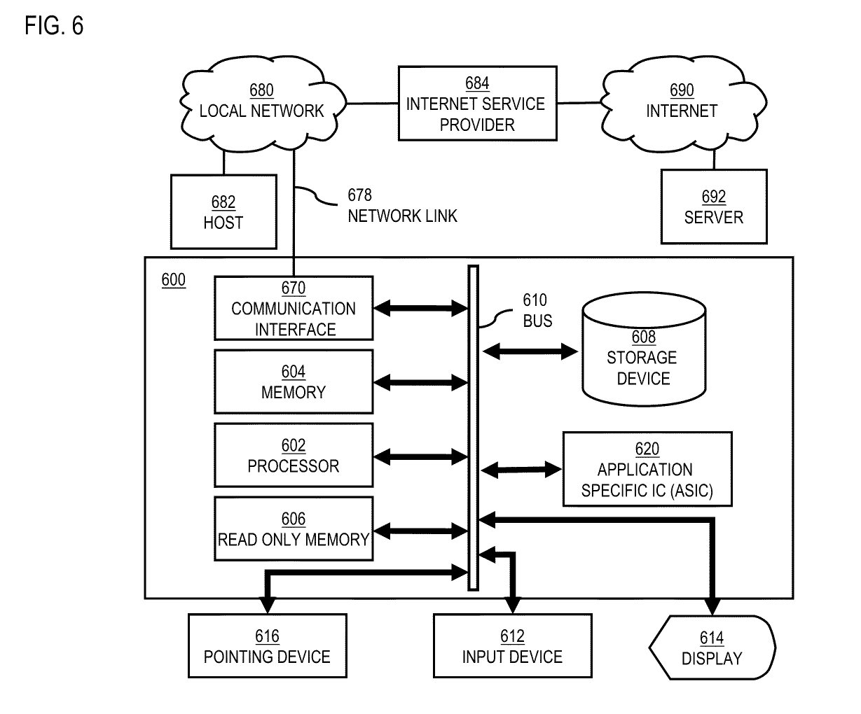

FIG. 6 illustrates a computer system 600 upon which an embodiment of the invention may be implemented. Although computer system 600 is depicted with respect to a particular device or equipment, it is contemplated that other devices or equipment (e.g., network elements, servers, etc.) within FIG. 6 can deploy the illustrated hardware and components of system 600. Computer system 600 is programmed (e.g., via computer program code or instructions) to suggest information resources 111 based on context and preferences as described herein and includes a communication mechanism such as a bus 610 for passing information between other internal and external components of the computer system 600. Information (also called data) is represented as a physical expression of a measurable phenomenon, typically electric voltages, but including, in other embodiments, such phenomena as magnetic, electromagnetic, pressure, chemical, biological, molecular, atomic, sub-atomic and quantum interactions. For example, north and south magnetic fields, or a zero and non-zero electric voltage, represent two states (0, 1) of a binary digit (bit). Other phenomena can represent digits of a higher base. A superposition of multiple simultaneous quantum states before measurement represents a quantum bit (qubit). A sequence of one or more digits constitutes digital data that is used to represent a number or code for a character. In some embodiments, information called analog data is represented by a near continuum of measurable values within a particular range. Computer system 600, or a portion thereof, constitutes a means for performing one or more steps of suggesting information resources 111 based on context and preferences.

A bus 610 includes one or more parallel conductors of information so that information is transferred quickly among devices coupled to the bus 610. One or more processors 602 for processing information are coupled with the bus 610.

A processor 602 performs a set of operations on information as specified by computer program code related to suggest information resources 111 based on context and preferences. The computer program code is a set of instructions or statements providing instructions for the operation of the processor and/or the computer system to perform specified functions. The code, for example, may be written in a computer programming language that is compiled into a native instruction set of the processor. The code may also be written directly using the native instruction set (e.g., machine language). The set of operations include bringing information in from the bus 610 and placing information on the bus 610. The set of operations also typically include comparing two or more units of information, shifting positions of units of information, and combining two or more units of information, such as by addition or multiplication or logical operations like OR, exclusive OR (XOR), and AND. Each operation of the set of operations that can be performed by the processor is represented to the processor by information called instructions, such as an operation code of one or more digits. A sequence of operations to be executed by the processor 602, such as a sequence of operation codes, constitute processor instructions, also called computer system instructions or, simply, computer instructions. Processors may be implemented as mechanical, electrical, magnetic, optical, chemical or quantum components, among others, alone or in combination.

Computer system 600 also includes a memory 604 coupled to bus 610. The memory 604, such as a random access memory (RAM) or other dynamic storage device, stores information including processor instructions for suggesting information resources 111 based on context and preferences. Dynamic memory allows information stored therein to be changed by the computer system 600. RAM allows a unit of information stored at a location called a memory address to be stored and retrieved independently of information at neighboring addresses. The memory 604 is also used by the processor 602 to store temporary values during execution of processor instructions. The computer system 600 also includes a read only memory (ROM) 606 or other static storage device coupled to the bus 610 for storing static information, including instructions, that is not changed by the computer system 600. Some memory is composed of volatile storage that loses the information stored thereon when power is lost. Also coupled to bus 610 is a non-volatile (persistent) storage device 608, such as a magnetic disk, optical disk or flash card, for storing information, including instructions, that persists even when the computer system 600 is turned off or otherwise loses power.

Information, including instructions for suggesting information resources 111 based on context and preferences, is provided to the bus 610 for use by the processor from an external input device 612, such as a keyboard containing alphanumeric keys operated by a human user, or a sensor. A sensor detects conditions in its vicinity and transforms those detections into physical expression compatible with the measurable phenomenon used to represent information in computer system 600. Other external devices coupled to bus 610, used primarily for interacting with humans, include a display device 614, such as a cathode ray tube (CRT) or a liquid crystal display (LCD), or plasma screen or printer for presenting text or images, and a pointing device 616, such as a mouse or a trackball or cursor direction keys, or motion sensor, for controlling a position of a small cursor image presented on the display 614 and issuing commands associated with graphical elements presented on the display 614. In some embodiments, for example, in embodiments in which the computer system 600 performs all functions automatically without human input, one or more of external input device 612, display device 614 and pointing device 616 is omitted.

In the illustrated embodiment, special purpose hardware, such as an application specific integrated circuit (ASIC) 620, is coupled to bus 610. The special purpose hardware is configured to perform operations not performed by processor 602 quickly enough for special purposes. Examples of application specific ICs include graphics accelerator cards for generating images for display 614, cryptographic boards for encrypting and decrypting messages sent over a network, speech recognition, and interfaces to special external devices, such as robotic arms and medical scanning equipment that repeatedly perform some complex sequence of operations that are more efficiently implemented in hardware.

Computer system 600 also includes one or more instances of a communications interface 670 coupled to bus 610. Communication interface 670 provides a one-way or two-way communication coupling to a variety of external devices that operate with their own processors, such as printers, scanners and external disks. In general the coupling is with a network link 678 that is connected to a local network 680 to which a variety of external devices with their own processors are connected. For example, communication interface 670 may be a parallel port or a serial port or a universal serial bus (USB) port on a personal computer. In some embodiments, communications interface 670 is an integrated services digital network (ISDN) card or a digital subscriber line (DSL) card or a telephone modem that provides an information communication connection to a corresponding type of telephone line. In some embodiments, a communication interface 670 is a cable modem that converts signals on bus 610 into signals for a communication connection over a coaxial cable or into optical signals for a communication connection over a fiber optic cable. As another example, communications interface 670 may be a local area network (LAN) card to provide a data communication connection to a compatible LAN, such as Ethernet. Wireless links may also be implemented. For wireless links, the communications interface 670 sends or receives or both sends and receives electrical, acoustic or electromagnetic signals, including infrared and optical signals, that carry information streams, such as digital data. For example, in wireless handheld devices, such as mobile telephones like cell phones, the communications interface 670 includes a radio band electromagnetic transmitter and receiver called a radio transceiver. In certain embodiments, the communications interface 670 enables connection to the communication network 105 for suggesting information resources 111 based on context and preferences.

The term “computer-readable medium” as used herein refers to any medium that participates in providing information to processor 602, including instructions for execution. Such a medium may take many forms, including, but not limited to computer-readable storage medium (e.g., non-volatile media, volatile media), and transmission media. Non-transitory media, such as non-volatile media, include, for example, optical or magnetic disks, such as storage device 608. Volatile media include, for example, dynamic memory 604. Transmission media include, for example, coaxial cables, copper wire, fiber optic cables, and carrier waves that travel through space without wires or cables, such as acoustic waves and electromagnetic waves, including radio, optical and infrared waves. Signals include man-made transient variations in amplitude, frequency, phase, polarization or other physical properties transmitted through the transmission media. Common forms of computer-readable media include, for example, a floppy disk, a flexible disk, hard disk, magnetic tape, any other magnetic medium, a CD-ROM, CDRW, DVD, any other optical medium, punch cards, paper tape, optical mark sheets, any other physical medium with patterns of holes or other optically recognizable indicia, a RAM, a PROM, an EPROM, a FLASH-EPROM, any other memory chip or cartridge, a carrier wave, or any other medium from which a computer can read. The term computer-readable storage medium is used herein to refer to any computer-readable medium except transmission media.

Logic encoded in one or more tangible media includes one or both of processor instructions on a computer-readable storage media and special purpose hardware, such as ASIC 620.

Network link 678 typically provides information communication using transmission media through one or more networks to other devices that use or process the information. For example, network link 678 may provide a connection through local network 680 to a host computer 682 or to equipment 684 operated by an Internet Service Provider (ISP). ISP equipment 684 in turn provides data communication services through the public, world-wide packet-switching communication network of networks now commonly referred to as the Internet 690.

A computer called a server host 692 connected to the Internet hosts a process that provides a service in response to information received over the Internet. For example, server host 692 hosts a process that provides information representing video data for presentation at display 614. It is contemplated that the components of system 600 can be deployed in various configurations within other computer systems, e.g., host 682 and server 692.

At least some embodiments of the invention are related to the use of computer system 600 for implementing some or all of the techniques described herein. According to one embodiment of the invention, those techniques are performed by computer system 600 in response to processor 602 executing one or more sequences of one or more processor instructions contained in memory 604. Such instructions, also called computer instructions, software and program code, may be read into memory 604 from another computer-readable medium such as storage device 608 or network link 678. Execution of the sequences of instructions contained in memory 604 causes processor 602 to perform one or more of the method steps described herein. In alternative embodiments, hardware, such as ASIC 620, may be used in place of or in combination with software to implement the invention. Thus, embodiments of the invention are not limited to any specific combination of hardware and software, unless otherwise explicitly stated herein.

The signals transmitted over network link 678 and other networks through communications interface 670, carry information to and from computer system 600. Computer system 600 can send and receive information, including program code, through the networks 680, 690 among others, through network link 678 and communications interface 670. In an example using the Internet 690, a server host 692 transmits program code for a particular application, requested by a message sent from computer 600, through Internet 690, ISP equipment 684, local network 680 and communications interface 670. The received code may be executed by processor 602 as it is received, or may be stored in memory 604 or in storage device 608 or other non-volatile storage for later execution, or both. In this manner, computer system 600 may obtain application program code in the form of signals on a carrier wave.

Various forms of computer readable media may be involved in carrying one or more sequence of instructions or data or both to processor 602 for execution. For example, instructions and data may initially be carried on a magnetic disk of a remote computer such as host 682. The remote computer loads the instructions and data into its dynamic memory and sends the instructions and data over a telephone line using a modem. A modem local to the computer system 600 receives the instructions and data on a telephone line and uses an infra-red transmitter to convert the instructions and data to a signal on an infra-red carrier wave serving as the network link 678. An infrared detector serving as communications interface 670 receives the instructions and data carried in the infrared signal and places information representing the instructions and data onto bus 610. Bus 610 carries the information to memory 604 from which processor 602 retrieves and executes the instructions using some of the data sent with the instructions. The instructions and data received in memory 604 may optionally be stored on storage device 608, either before or after execution by the processor 602.

FIG. 7 illustrates a chip set 700 upon which an embodiment of the invention may be implemented. Chip set 700 is programmed to suggest information resources 111 based on context and preferences as described herein and includes, for instance, the processor and memory components described with respect to FIG. 6 incorporated in one or more physical packages (e.g., chips). By way of example, a physical package includes an arrangement of one or more materials, components, and/or wires on a structural assembly (e.g., a baseboard) to provide one or more characteristics such as physical strength, conservation of size, and/or limitation of electrical interaction. It is contemplated that in certain embodiments the chip set can be implemented in a single chip. Chip set 700, or a portion thereof, constitutes a means for performing one or more steps of suggesting information resources 111 based on context and preferences.

In one embodiment, the chip set 700 includes a communication mechanism such as a bus 701 for passing information among the components of the chip set 700. A processor 703 has connectivity to the bus 701 to execute instructions and process information stored in, for example, a memory 705. The processor 703 may include one or more processing cores with each core configured to perform independently. A multi-core processor enables multiprocessing within a single physical package. Examples of a multi-core processor include two, four, eight, or greater numbers of processing cores. Alternatively or in addition, the processor 703 may include one or more microprocessors configured in tandem via the bus 701 to enable independent execution of instructions, pipelining, and multithreading. The processor 703 may also be accompanied with one or more specialized components to perform certain processing functions and tasks such as one or more digital signal processors (DSP) 707, or one or more application-specific integrated circuits (ASIC) 709. A DSP 707 typically is configured to process real-world signals (e.g., sound) in real time independently of the processor 703. Similarly, an ASIC 709 can be configured to performed specialized functions not easily performed by a general purposed processor. Other specialized components to aid in performing the inventive functions described herein include one or more field programmable gate arrays (FPGA) (not shown), one or more controllers (not shown), or one or more other special-purpose computer chips.

The processor 703 and accompanying components have connectivity to the memory 705 via the bus 701. The memory 705 includes both dynamic memory (e.g., RAM, magnetic disk, writable optical disk, etc.) and static memory (e.g., ROM, CD-ROM, etc.) for storing executable instructions that when executed perform the inventive steps described herein to suggest information resources 111 based on context and preferences. The memory 705 also stores the data associated with or generated by the execution of the inventive steps.

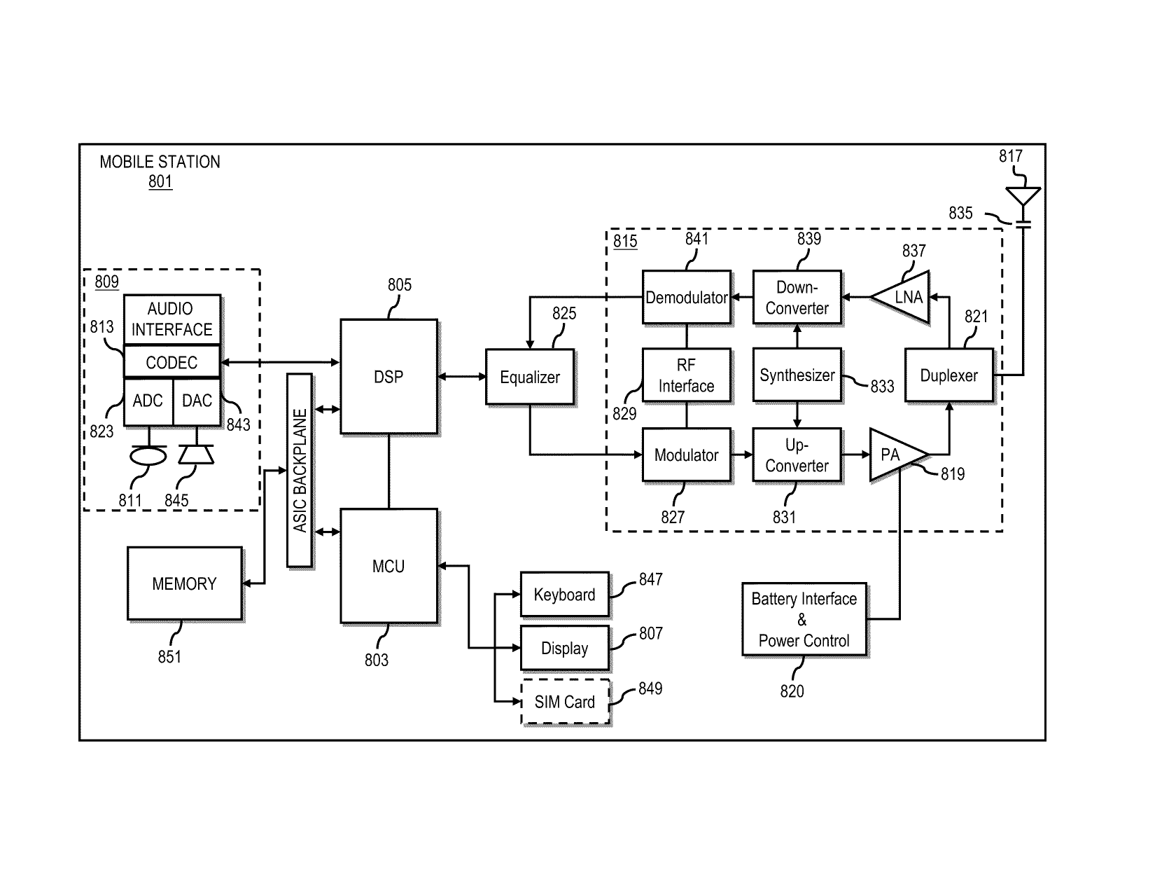

FIG. 8 is a diagram of exemplary components of a mobile terminal (e.g., handset) for communications, which is capable of operating in the system of FIG. 1, according to one embodiment. In some embodiments, mobile terminal 800, or a portion thereof, constitutes a means for performing one or more steps of suggesting information resources 111 based on context and preferences. Generally, a radio receiver is often defined in terms of front-end and back-end characteristics. The front-end of the receiver encompasses all of the Radio Frequency (RF) circuitry whereas the back-end encompasses all of the base-band processing circuitry. As used in this application, the term “circuitry” refers to both: (1) hardware-only implementations (such as implementations in only analog and/or digital circuitry), and (2) to combinations of circuitry and software (and/or firmware) (such as, if applicable to the particular context, to a combination of processor(s), including digital signal processor(s), software, and memory(ies) that work together to cause an apparatus, such as a mobile phone or server, to perform various functions). This definition of “circuitry” applies to all uses of this term in this application, including in any claims. As a further example, as used in this application and if applicable to the particular context, the term “circuitry” would also cover an implementation of merely a processor (or multiple processors) and its (or their) accompanying software/or firmware. The term “circuitry” would also cover if applicable to the particular context, for example, a baseband integrated circuit or applications processor integrated circuit in a mobile phone or a similar integrated circuit in a cellular network device or other network devices.

Pertinent internal components of the telephone include a Main Control Unit (MCU) 803, a Digital Signal Processor (DSP) 805, and a receiver/transmitter unit including a microphone gain control unit and a speaker gain control unit. A main display unit 807 provides a display to the user in support of various applications and mobile terminal functions that perform or support the steps of suggesting information resources 111 based on context and preferences. The display 8 includes display circuitry configured to display at least a portion of a user interface of the mobile terminal (e.g., mobile telephone). Additionally, the display 807 and display circuitry are configured to facilitate user control of at least some functions of the mobile terminal. An audio function circuitry 809 includes a microphone 811 and microphone amplifier that amplifies the speech signal output from the microphone 811. The amplified speech signal output from the microphone 811 is fed to a coder/decoder (CODEC) 813.

A radio section 815 amplifies power and converts frequency in order to communicate with a base station, which is included in a mobile communication system, via antenna 817. The power amplifier (PA) 819 and the transmitter/modulation circuitry are operationally responsive to the MCU 803, with an output from the PA 819 coupled to the duplexer 821 or circulator or antenna switch, as known in the art. The PA 819 also couples to a battery interface and power control unit 820.

In use, a user of mobile terminal 801 speaks into the microphone 811 and his or her voice along with any detected background noise is converted into an analog voltage. The analog voltage is then converted into a digital signal through the Analog to Digital Converter (ADC) 823. The control unit 803 routes the digital signal into the DSP 805 for processing therein, such as speech encoding, channel encoding, encrypting, and interleaving. In one embodiment, the processed voice signals are encoded, by units not separately shown, using a cellular transmission protocol such as global evolution (EDGE), general packet radio service (GPRS), global system for mobile communications (GSM), Internet protocol multimedia subsystem (IMS), universal mobile telecommunications system (UMTS), etc., as well as any other suitable wireless medium, e.g., microwave access (WiMAX), Long Term Evolution (LTE) networks, code division multiple access (CDMA), wideband code division multiple access (WCDMA), wireless fidelity (WiFi), satellite, and the like.

The encoded signals are then routed to an equalizer 825 for compensation of any frequency-dependent impairments that occur during transmission though the air such as phase and amplitude distortion. After equalizing the bit stream, the modulator 827 combines the signal with a RF signal generated in the RF interface 829. The modulator 827 generates a sine wave by way of frequency or phase modulation. In order to prepare the signal for transmission, an up-converter 831 combines the sine wave output from the modulator 827 with another sine wave generated by a synthesizer 833 to achieve the desired frequency of transmission. The signal is then sent through a PA 819 to increase the signal to an appropriate power level. In practical systems, the PA 819 acts as a variable gain amplifier whose gain is controlled by the DSP 805 from information received from a network base station. The signal is then filtered within the duplexer 821 and optionally sent to an antenna coupler 835 to match impedances to provide maximum power transfer. Finally, the signal is transmitted via antenna 817 to a local base station. An automatic gain control (AGC) can be supplied to control the gain of the final stages of the receiver. The signals may be forwarded from there to a remote telephone which may be another cellular telephone, other mobile phone or a land-line connected to a Public Switched Telephone Network (PSTN), or other telephony networks.

Voice signals transmitted to the mobile terminal 801 are received via antenna 817 and immediately amplified by a low noise amplifier (LNA) 837. A down-converter 839 lowers the carrier frequency while the demodulator 841 strips away the RF leaving only a digital bit stream. The signal then goes through the equalizer 825 and is processed by the DSP 805. A Digital to Analog Converter (DAC) 843 converts the signal and the resulting output is transmitted to the user through the speaker 845, all under control of a Main Control Unit (MCU) 803—which can be implemented as a Central Processing Unit (CPU) (not shown).

The MCU 803 receives various signals including input signals from the keyboard 847. The keyboard 847 and/or the MCU 803 in combination with other user input components (e.g., the microphone 811) comprise a user interface circuitry for managing user input. The MCU 803 runs a user interface software to facilitate user control of at least some functions of the mobile terminal 801 to suggest information resources 111 based on context and preferences. The MCU 803 also delivers a display command and a switch command to the display 807 and to the speech output switching controller, respectively. Further, the MCU 803 exchanges information with the DSP 805 and can access an optionally incorporated SIM card 849 and a memory 851. In addition, the MCU 803 executes various control functions required of the terminal. The DSP 805 may, depending upon the implementation, perform any of a variety of conventional digital processing functions on the voice signals. Additionally, DSP 805 determines the background noise level of the local environment from the signals detected by microphone 811 and sets the gain of microphone 811 to a level selected to compensate for the natural tendency of the user of the mobile terminal 801.

The CODEC 813 includes the ADC 823 and DAC 843. The memory 851 stores various data including call incoming tone data and is capable of storing other data including music data received via, e.g., the global Internet. The software module could reside in RAM memory, flash memory, registers, or any other form of writable storage medium known in the art. The memory device 851 may be, but not limited to, a single memory, CD, DVD, ROM, RAM, EEPROM, optical storage, or any other non-volatile storage medium capable of storing digital data.

An optionally incorporated SIM card 849 carries, for instance, important information, such as the cellular phone number, the carrier supplying service, subscription details, and security information. The SIM card 849 serves primarily to identify the mobile terminal 801 on a radio network. The card 849 also contains a memory for storing a personal telephone number registry, text messages, and user specific mobile terminal settings.

While the invention has been described in connection with a number of embodiments and implementations, the invention is not so limited but covers various obvious modifications and equivalent arrangements, which fall within the purview of the appended claims. Although features of the invention are expressed in certain combinations among the claims, it is contemplated that these features can be arranged in any combination and order.

What is claimed is:

1. A method comprising:
retrieving a predetermined set of a plurality of information resources associated with a user;
extracting language tokens from the information resources;
creating a model of the predetermined set of information resources by applying a probabilistic analysis on the language tokens;
matching the model against a context vocabulary to generate a context template for each of the information resources; and
matching the model against a preference vocabulary to generate a preference template for each of the information resources.

2. A method of claim 1, further comprising:
determining contextual characteristics of a device associated with the user;
matching the contextual characteristics against the context templates generated for the information resources; and
suggesting one or more of the information resources to the user based, at least in part, on the matching of the contextual characteristics.

3. A method of claim 2, further comprising:
receiving an input from the user, another user, or a group of users for specifying preference information;
matching the preference information against the preference templates generated for the information resources; and
suggesting one or more of the information resources to the user based, at least in part, on the matching of the preference information.

4. A method of claim 3, further comprising:
establishing a hierarchy of the contextual characteristics, the preference information, or a combination thereof;
matching the hierarchy against the context templates, the preference templates, or both; and
suggesting one or more of the information resources based, at least in part, on the matching of the hierarchy.

5. A method of claim 4, further comprising:
categorizing the suggested one or more of the information resources according to the hierarchy;
presenting the suggested one or more information resources based on a predetermined minimum or a predetermined maximum number of information resources to present in each level of the hierarchy; and
causing, at least in part, access of a selected one or more of the suggested information resources.

6. A method of claim 1, wherein one or more of the information resources are specified by a third party, the method further comprising:
receiving an input from the third party for defining an applicable context for each of the one or more information resources specified by the third party, the applicable context specifying when the corresponding information source will become relevant,
wherein the applicable context is incorporated in the context template generated for each of the information resources specified by the third party, and wherein the applicable context includes, at least in part, a date, a time, a location, an activity of the user, or a combination thereof.

7. A method of claim 1, wherein the contextual characteristics are determined by the device, a service, another device, a group of devices, or a combination thereof, and include a date, a time, a location, an activity of the user, or a combination thereof

8. A method of claim 1, wherein the predetermined set of information resources is specified by the user, another user, a group of users, a third party, or a combination thereof.

9. An apparatus comprising:
at least one processor; and
at least one memory including computer program code, the at least one memory and the computer program code configured to, with the at least one processor, cause the apparatus to perform at least the following,
retrieve a predetermined set of a plurality of information resources associated with a user,
extract language tokens from the information resources,
create a model of the predetermined set of information resources by applying a probabilistic analysis on the language tokens,
match the model against a context vocabulary to generate a context template for each of the information resources; and
match the model against a preference vocabulary to generate a preference template for each of the information resources.

10. An apparatus of claim 1, wherein the apparatus is further caused to:
determine contextual characteristics of a device associated with the user;
match the contextual characteristics against the context templates generated for the information resources; and
suggest one or more of the information resources to the user based, at least in part, on the matching of the contextual characteristics.

11. An apparatus of claim 10, wherein the apparatus is further caused to:
receive an input from the user, another user, or a group of users for specifying preference information;
match the preference information against the preference templates generated for the information resources; and
suggest one or more of the information resources to the user based, at least in part, on the matching of the preference information.

12. An apparatus of claim 11, wherein the apparatus is further caused to:
establish a hierarchy of the contextual characteristics, the preference information, or a combination thereof;
match the hierarchy against the context templates, the preference templates, or both; and
suggest one or more of the information resources based, at least in part, on the matching of the hierarchy.

13. An apparatus of claim 12, wherein the apparatus is further caused to:
categorize the suggested one or more of the information resources according to the hierarchy;
present the suggested one or more information resources based on a predetermined minimum or a predetermined maximum number of information resources to present in each level of the hierarchy; and
cause, at least in part, access of a selected one or more of the suggested information resources.

14. An apparatus of claim 9, wherein one or more of the information resources are specified by a third party, and the apparatus is further caused to:
receive an input from the third party for defining an applicable context for each of the one or more information resources specified by the third party, the applicable context specifying when the corresponding information source will become relevant,
wherein the applicable context is incorporated in the context template generated for each of the information resources specified by the third party, and wherein the applicable context includes, at least in part, a date, a time, a location, an activity of the user, or a combination thereof.

15. An apparatus of claim 9, wherein the contextual characteristics are determined by the device, a service, another device, a group of devices, or a combination thereof, and include a date, a time, a location, an activity of the user, or a combination thereof

16. An apparatus of claim 9, wherein the predetermined set of information resources is specified by the user, another user, a group of users, a third party, or a combination thereof

17. An apparatus of claim 9, wherein the apparatus is a mobile phone further comprising:
user interface circuitry and user interface software configured to facilitate user control of at least some functions of the mobile phone through use of a display and configured to respond to user input; and
a display and display circuitry configured to display at least a portion of a user interface of the mobile phone, the display and display circuitry configured to facilitate user control of at least some functions of the mobile phone.

18. A computer-readable storage medium carrying one or more sequences of one or more instructions which, when executed by one or more processors, cause an apparatus to at least perform the following steps:
retrieving a predetermined set of a plurality of information resources associated with a user;
extracting language tokens from the information resources;
creating a model of the predetermined set of information resources by applying a probabilistic analysis on the language tokens;
matching the model against a context vocabulary to generate a context template for each of the information resources; and
matching the model against a preference vocabulary to generate a preference template for each of the information resources.

19. A computer readable storage medium of claim 18, wherein the apparatus is further caused to perform:
determining contextual characteristics of a device associated with the user;
matching the contextual characteristics against the context templates generated for the information resources; and
suggesting one or more of the information resources to the user based, at least in part, on the matching of the contextual characteristics.

20. A computer readable storage medium of claim 19, wherein the apparatus is further caused to perform:
receiving an input from the user, another user, or a group of users for specifying preference information;
matching the preference information against the preference templates generated for the information resources; and
suggesting one or more of the information resources to the user based, at least in part, on the matching of the preference information.
